(19) United States
(12) Patent Application Publication
(10) Pub. No.: US 2026/0063907 A1
(43) Pub. Date: Mar. 5, 2026

(54) VIRTUAL IMAGE DISPLAY APPARATUS AND OPTICAL UNIT

(71) Applicant: SEIKO EPSON CORPORATION, Tokyo (JP)

(72) Inventor: Toshiyuki NOGUCHI, SHIOJIRI-SHI (JP)

(73) Assignee: SEIKO EPSON CORPORATION, Tokyo (JP)

(21) Appl. No.: 19/312,325

(22) Filed: Aug. 28, 2025

(30) Foreign Application Priority Data
Aug. 30, 2024 (JP) 2024-148501

(51) Int. Cl. G02B 27/01; G02B 27/28

(52) U.S. Cl. CPC G02B 27/0172; G02B 27/286; G02B 27/288; G02B 2027/0114; G02B 2027/0178

(57) ABSTRACT

A direct-virtual-image-type virtual image display apparatus includes: a display element; a first lens that image light from the display element enters; a first prism that the image light passing through the first lens enters; a second prism bonded to the first prism; an inclining mirror portion provided at a location where the first prism and the second prism are bonded to each other and configured to reflect at least part of the image light guided in the first prism; a planoconvex second lens disposed so as to face a first outer surface of the first prism; and a transmissive mirror formed on a convex surface of the second lens and configured to partially reflect the image light, and the second prism includes a polarized light absorbing member at a surface excluding a second outer surface facing an outside.

The present application is based on, and claims priority from JP Application Serial Number 2024-148501, filed Aug. 30, 2024, the disclosure of which is hereby incorporated by reference herein in its entirety.

### BACKGROUND

### Technical Field

The present disclosure relates to a virtual image display apparatus and an optical unit that enable observation of a virtual image.

### Description of Related Art

There is a known head-mounted display which includes a display device, a projection optical member, a prism member, and a light collecting and reflecting surface, and in which image light from the projection optical member enters a first prism of the prism member, is totally reflected off an outer surface of the first prism, is partially reflected off a semi-transmissive and reflective surface formed at the boundary between the first prism and a second prism of the prism member, then passes through the outer surface of the prism member, is reflected off the light collecting and reflecting surface, returns into the prism member, passes through the semi-transmissive and reflective surface, and further passes through an inner surface facing a pupil (see JP-A-2020-008749).

JP-A-2020-008749 is an example of the related art.

The head-mounted display described above, in which an intermediate image is formed in the first prism, has a problem of a long optical path length and hence a large optical system as a whole.

### SUMMARY

A direct-virtual-image-type virtual image display apparatus according to an aspect of the present disclosure includes: a display element configured to output image light; a first lens that the image light from the display element enters; a first prism that the image light passing through the first lens enters; a second prism bonded to the first prism to constitute a plane-parallel-plate-shaped prism-based light guide member; an inclining mirror portion provided at a location where the first prism and the second prism are bonded to each other and configured to reflect at least part of the image light guided in the first prism; a planoconvex second lens disposed so as to face a first outer surface of the first prism that is a surface on which the image light reflected off the inclining mirror portion is incident; and a transmissive mirror formed on a convex surface of the second lens and configured to partially reflect toward the inclining mirror portion the image light reflected off the inclining mirror portion, and the second prism includes a polarized light absorbing member at a surface excluding a second outer surface facing an outside.

A direct-virtual-image-type optical unit according to another aspect of the present disclosure includes: a first lens that image light from a display element enters; a first prism that the image light passing through the first lens enters; a second prism bonded to the first prism to constitute a plane-parallel-plate-shaped prism-based light guide member; an inclining mirror portion provided at a location where the first prism and the second prism are bonded to each other and configured to reflect at least part of the image light guided in the first prism; a planoconvex second lens disposed so as to face a first outer surface of the first prism that is a surface on which the image light reflected off the inclining mirror portion is incident; and a transmissive mirror formed on a convex surface of the second lens and configured to partially reflect toward the inclining mirror portion the image light reflected off the inclining mirror portion, and the second prism includes a polarized light absorbing member at a surface excluding a second outer surface facing an outside.

### BRIEF DESCRIPTION OF THE DRAWINGS

FIG. 1 is an appearance view illustrating a state in which a virtual image display apparatus according to a first embodiment is used.

FIG. 2 is a side cross-sectional view illustrating an internal structure of the virtual image display apparatus on one side.

FIG. 3 is a perspective view of the virtual image display apparatus.

FIG. 4 illustrates the optical path and the like of the virtual image display apparatus shown in FIG. 2.

FIG. 5 illustrates the optical path and the like of a virtual image display apparatus according to Comparative Example.

FIG. 6 illustrates an example of the structure and assembly of a first display portion.

FIG. 7 is a side cross-sectional view illustrating a virtual image display apparatus according to a second embodiment.

FIG. 8 is a perspective view of a first prism and a second prism shown in FIG. 7.

FIG. 9 illustrates the optical path and the like of the virtual image display apparatus shown in FIG. 7.

FIG. 10 is a side cross-sectional view illustrating a virtual image display apparatus according to a third embodiment.

FIG. 11 illustrates the optical path and the like of the virtual image display apparatus shown in FIG. 10.

FIG. 12 is a side cross-sectional view illustrating a virtual image display apparatus according to a fourth embodiment.

FIG. 13 is a perspective view of the virtual image display apparatus shown in FIG. 12.

FIG. 14 is a side cross-sectional view illustrating a virtual image display apparatus according to a variation.

FIG. 15 illustrates the optical path and the like of the virtual image display apparatus shown in FIG. 14.

### DESCRIPTION OF THE EMBODIMENTS

### First Embodiment

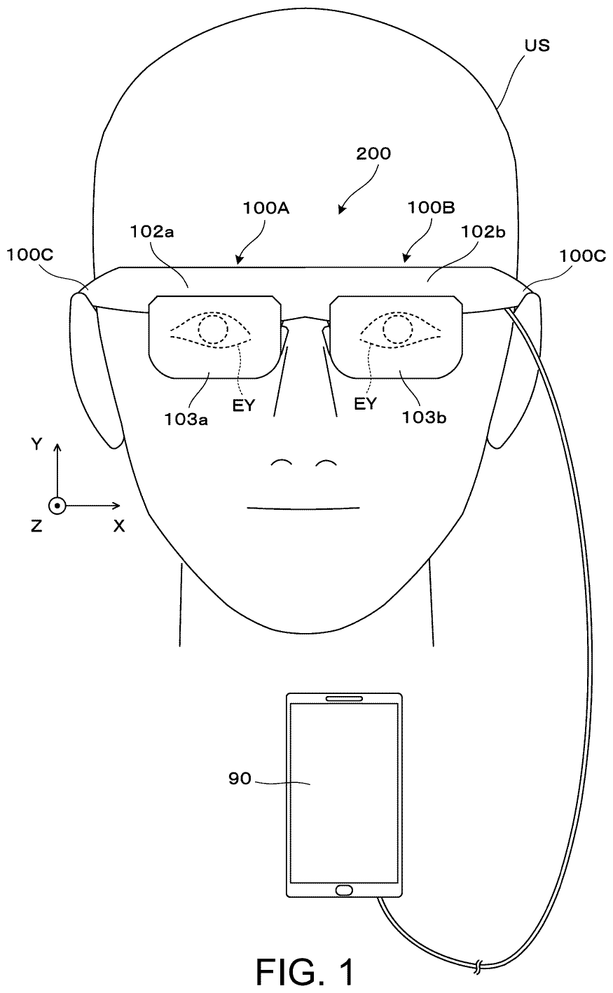

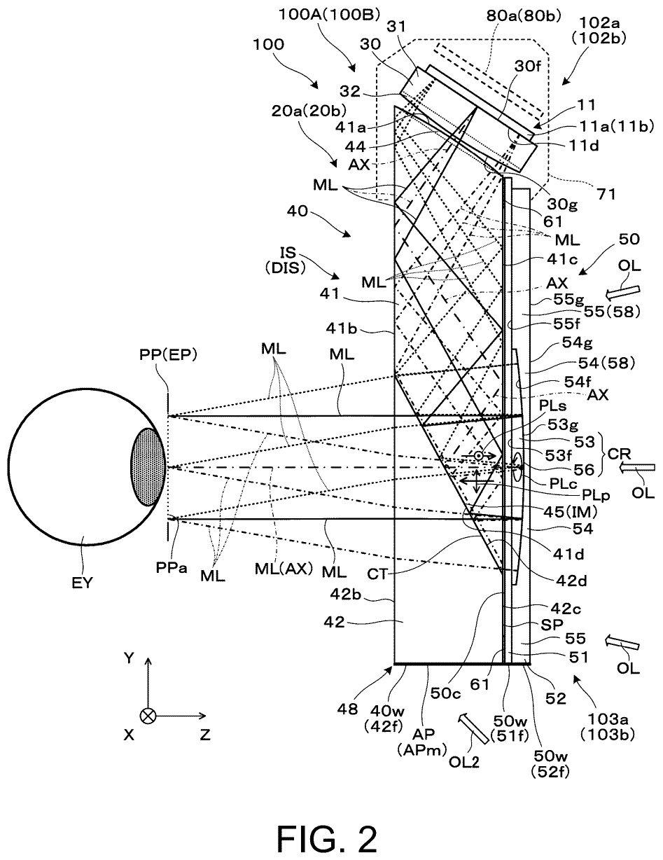

A first embodiment of a virtual image display apparatus and the like according to the present disclosure will be described below with reference to FIGS. 1, 2, and the like.

FIG. 1 illustrates a state in which a head-mounted virtual image display apparatus (hereinafter also referred to as head-mounted display or HMD) 200 is mounted. The HMD 200 causes an observer or wearer US who wears the HMD 200 to recognize an image in the form of a virtual image. In FIG. 1 and the like, X, Y, and Z represent an orthogonal coordinate system. A +X direction corresponds to a lateral direction in which two eyes EY of the observer or wearer US, who wears the HMD 200, are arranged. A +Y direction corresponds to an upward direction orthogonal to the lateral direction, in which the two eyes EY of the wearer US are arranged. A +Z direction corresponds to a forward direction or a front-side direction for the wearer US. The ±Y directions are parallel to the vertical axis or the vertical direction.

The HMD 200 includes a direct-virtual-image-type first virtual image display apparatus 100A for the right eye, a direct-virtual-image-type second virtual image display apparatus 100B for the left eye, a pair of temple-shaped support apparatuses 100C, which support the virtual image display apparatuses 100A and 100B, and a user terminal 90, which is an information terminal. The first virtual image display apparatus 100A independently functions as an HMD, and includes a first display driver 102a disposed at an upper portion of the display apparatus and a first combiner 103a, which has the shape of a spectacle lens and covers the front side of the eye. Similarly, the second virtual image display apparatus 100B independently functions as an HMD and includes a second display driver 102b disposed at an upper portion of the display apparatus and a second combiner 103b, which has the shape of a spectacle lens and covers the front side of the eye. The support apparatuses 100C are mounting members mounted on the head of the wearer US. The support apparatuses 100C support the upper ends of the pair of combiners 103a and 103b via the display drivers 102a and 102b integrated with the support apparatuses 100C in appearance. The first virtual image display apparatus 100A and the second virtual image display apparatus 100B are optically the same or horizontally symmetric. The second virtual image display apparatus 100B will not be described in detail.

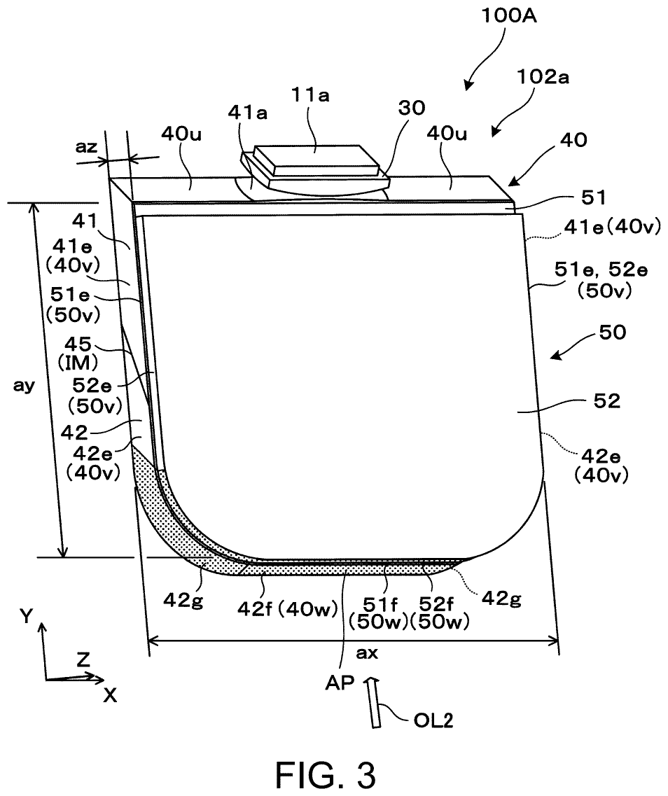

FIG. 2 is a side cross-sectional view illustrating an internal structure of the first virtual image display apparatus 100A. FIG. 3 is a perspective view of the first virtual image display apparatus 100A. The first virtual image display apparatus 100A includes a first image forming element 11a, a first display portion 20a, and a first circuit member 80a. The first image forming element 11a is also referred to as a display element 11. The first display portion 20a is an imaging optical system IS, which directly forms a virtual image without forming an intermediate image. The first display portion 20a is also referred to as a direct virtual image optical system DIS. The imaging optical system IS includes a first lens 30, a first planar-plate-shaped member 40, and a second planar-plate-shaped member 50. The first lens 30 functions as a protective glass portion that protects a display surface 11d of the display element 11. Note that a cover glass plate may be provided between the display element 11 and the first lens 30. The first planar-plate-shaped member 40 guides image light ML output from the display element 11 to a second lens 53 of the second planar-plate-shaped member 50. The second planar-plate-shaped member 50 reflects the image light ML from the first planar-plate-shaped member 40 toward a pupil position PP or the eyes EY so as to direct part of the image light ML back to the first planar-plate-shaped member 40, and causes outside light OL to be incident on the pupil position PP via the first planar-plate-shaped member 40. The first lens 30, the first planar-plate-shaped member 40, and the second planar-plate-shaped member 50 each function as a lens having positive refractive power.

Although not described in detail, the second virtual image display apparatus 100B includes a second image forming element 11b, a second display portion 20b, and a second circuit member 80b. The second image forming element 11b is the same as the first image forming element 11a. The second display portion 20b is the same as the first display portion 20a. The second circuit member 80b is the same as the first circuit member 80a.

In the first virtual image display apparatus 100A, the first image forming element 11a is a self-luminous image light generator. The first image forming element 11a outputs the image light ML to the first planar-plate-shaped member 40 via the first lens 30. The first image forming element 11a is housed in and supported by an enclosure 71. The first image forming element 11a is, for example, an organic electro-luminescence (EL) display. The first image forming element 11a forms a color still image or color video images on the display surface 11d, which is a two-dimensional surface. The first image forming element 11a is driven by the first circuit member 80a to perform display operation. The first image forming element 11a is not limited to an organic EL display, which can be replaced with a display device using an inorganic EL, an organic LED, an LED array, a laser array, a quantum dot luminous element, or the like. The first image forming element 11a is not limited to a self-luminous image light generator, and may be configured with an LCD or another light modulator and may form an image by illuminating the light modulator with light from a light source such as a backlight. As the first image forming element 11a, a liquid crystal on silicon (LCOS, LCOS is registered trademark) or the like can be used in place of an LCD. Note that in the first virtual image display apparatus 100A, an optical apparatus excluding the first circuit member 80a is referred to as an optical unit 100. It can be said that the optical unit 100 includes a direct-virtual-image-type optical system and is a portion corresponding to the direct virtual image optical system DIS, which constitutes the first virtual image display apparatus 100A.

The first display portion 20a includes the first lens 30, the first planar-plate-shaped member 40, an inclining mirror portion IM, and the second planar-plate-shaped member 50. In the first display portion 20a, the first lens 30 has positive refractive power, and the image light ML from the first image forming element 11a enters the first lens 30. The first lens 30 has a light incident planar surface 30f bonded to the first image forming element 11a, and a light exiting convex surface 30g. The light exiting convex surface 30g is, for example, a spherical surface, and may instead be an aspherical surface having an axisymmetric shape. The first lens 30 can be conceptually divided into a plane parallel plate 31 and a lens portion 32. Foreign matter having adhered to the surface of the first lens 30 is unlikely to be noticeable by ensuring that the thickness of the plane parallel plate 31 is greater than or equal to a predetermined value. The plane parallel plate 31 functions as a cover glass plate. The lens portion 32 is a planoconvex lens having positive refractive power. A planoconvex lens has one surface having a planar shape, and another surface having a convex shape. Note that the plane parallel plate 31 and the lens portion 32 may be bonded to each other or may be separate from each other. The lens portion 32 may not be a planoconvex lens, and may, for example, be a biconvex lens. The first lens 30 is made, for example, of fused quartz and has a relatively low refractive index.

The first planar-plate-shaped member 40 includes a plane-parallel-plate-shaped first prism 41 and a plane-parallel-plate-shaped second prism 42. The first prism 41 and the second prism 42 are bonded to each other at inclining surfaces 41d and 42d. The unit of the first prism 41 and the second prism 42 bonded to each other is referred to as a prism-based light guide member 48. The prism-based light guide member 48 has the appearance of a plane parallel plate. The inclining mirror portion IM, which is a planar surface, is formed on the first inclining surface 41d formed on the lower side of the first prism 41. The combination of the prism-based light guide member 48 and the second planar-plate-shaped member 50, which will be described later, corresponds to the first combiner 103a.

The first prism 41 has a quadrangular columnar outer shape and has a trapezoidal longitudinal cross-section. The first prism 41 guides the image light ML. The first prism 41 has a light incident optical surface 41a, a first inner surface 41b, a first outer surface 41c, and the first inclining surface 41d. The first prism 41 further has an upper planar surface 40u and a first lateral surface 41e (see FIG. 3). The first lateral surface 41e corresponds to a portion of a fifth lateral surface 40v of the prism-based light guide member 48. The light incident optical surface 41a inclines downward on the front side thereof as a whole, and the optical axis passing through the light incident optical surface 41a extends in a direction between the +Z direction, which extends toward the front side, and the +Y direction, which extends toward the upper side. The first image forming element 11a, which is the display element 11, is thus readily disposed outside the first inner surface 41b, so that an angle at which the image light ML propagates in the first prism 41 (in the first prism 41 or through the interior of the first prism 41) can be adjusted. The light incident optical surface 41a is a convex surface, for example, a spherical surface, and may instead be an axisymmetric aspherical surface. The first prism 41 can be taken as a prism including a lens portion 44 having the light incident optical surface 41a. The lens portion 44 is a planoconvex lens having positive refractive power. The lens portion 44 may be directly formed as a part of the first prism 41 or may be bonded to the first prism 41. The first inner surface 41b and the first outer surface 41c are parallel to each other and extend in a direction perpendicular to an optical axis AX between the pupil position PP and each of the two surfaces. The first inner surface 41b and the first outer surface 41c internally reflect the image light ML (that is, reflect image light ML off inner side of object surface), and in particular preferably totally reflect the image light ML. The scratch resistance or scuff resistance of the first inner surface 41b can be enhanced by providing the surface thereof with a hard coat. The first inclining surface 41d is a planar surface. The first inclining surface 41d inclines with respect to the first outer surface 41c by an acute angle that specifically ranges from 25° to 32°. The distance between the optical axis AX passing through the pupil position PP and the upper end of the first lens 30 is about 20 mm. The first prism 41 is made of a resin material.

The number of times of reflection of the image light ML in the first prism 41 is one at the first inner surface 41b, one at the first outer surface 41c, and one more time at the inclining mirror portion IM, which will be described later. Setting the number of times of internal reflection of the image light ML in the first prism 41 to two allows avoidance of mixture of multiple types of light reflected in the first prism 41 by different numbers of times while increasing the angle of view of the image light ML, the pupil position PP, or an aperture PPa at the pupil position PP. In addition, the distance from the display element 11 to a transmissive mirror 56 of a cover member 52, which will be described later, is readily shortened, so that the prism-based light guide member 48 can be reduced in size, and the display element 11 and the first lens 30 are also readily reduced in size.

The second prism 42 has a quadrangular columnar outer shape and has a trapezoidal longitudinal cross-section, as the first prism 41. The second prism 42 transmits the image light ML. The second prism 42 has a second inner surface 42b, a second outer surface 42c, the second inclining surface 42d, and a first bottom surface 42f. The first bottom surface 42f corresponds to a fourth bottom surface 40w of the prism-based light guide member 48 or the first planar-plate-shaped member 40. The first bottom surface 42f is a surface of the prism-based light guide member 48 or the first planar-plate-shaped member 40 that is the surface opposite or facing the light incident optical surface 41a. The first bottom surface 42f is a surface of the second prism 42 that is the surface opposite or facing the second inclining surface 42d. The second prism 42 has a second lateral surface 42e (see FIG. 3). The second lateral surface 42e corresponds to a portion of the fifth lateral surface 40v of the prism-based light guide member 48. The second inner surface 42b and the second outer surface 42c are parallel to each other, and extend in a direction perpendicular to the optical axis AX between the pupil position PP and each of the two surfaces. The scratch resistance of the second inner surface 42b can be enhanced by providing the surface with a hard coat. The second prism 42 is made of a resin material.

The second prism 42 includes a polarized light absorbing member AP at any surface excluding the second outer surface 42c facing the outside. A see-through ghost that is an outside light ghost resulting from unnecessary outside light OL2 is thus suppressed. Specifically, the surfaces excluding the second outer surface 42c facing the outside are the second inner surface 42b, the second inclining surface 42d, the second lateral surface 42c, and the first bottom surface 42f. The second inner surface 42b, the second lateral surface 42c, and the first bottom surface 42f are exposed surfaces of the second prism 42 or the prism-based light guide member 48. The second inclining surface 42d is a non-exposed surface of the second prism 42 or the prism-based light guide member 48 that is the surface facing the inclining mirror portion IM. The unnecessary outside light OL2 is outside light traveling in an unintended direction, and is light incident via surfaces other than the front surface of the first virtual image display apparatus 100A, that is, surfaces other than a surface of the second planar-plate-shaped member 50 that is the surface facing the outside. Since the unnecessary outside light OL2 is captured in the field of view in the form of the see-through ghost, the field of view may significantly deteriorate, which will be described later in detail. The polarized light absorbing member AP is disposed at an appropriate surface of the second prism 42 described above to absorb or block predetermined polarized light of the unnecessary outside light OL2 and therefore suppress the influence of the unnecessary outside light OL2.

In the present embodiment, the polarized light absorbing member AP is disposed at the first bottom surface 42f of the second prism 42. That is, the polarized light absorbing member AP is provided at the first bottom surface 42f of the second prism 42. Since the unnecessary outside light OL2 incident from the obliquely lower front side of the second prism 42 or the prism-based light guide member 48 passes through the polarized light absorbing member AP before being incident on the inclining mirror portion IM, reflection of the unnecessary outside light OL2 at the inclining mirror portion IM is suppressed. A situation in which the unnecessary outside light OL2 reaches the eyes EY of the wearer US can therefore be suppressed. It is more preferable that the polarized light absorbing member AP is disposed at the first bottom surface 42f of the second prism 42, a second bottom surface 51f of a quarter-wave plate 51, and a third bottom surface 52f of the cover member 52 housing the second lens 53 and the transmissive mirror 56, as shown in FIG. 2 and the like. The second bottom surface 51f and the third bottom surface 52f correspond to a fifth bottom surface 50w of the second planar-plate-shaped member 50. That is, the polarized light absorbing member AP is disposed across the bottom surface 40w of the first planar-plate-shaped member 40 and the bottom surface 50w of the second planar-plate-shaped member 50. The see-through ghost can thus be further suppressed.

The second prism 42 has a curved surface 42g at the boundary between the first bottom surface 42f and the second lateral surface 42c, as shown in FIG. 3. The polarized light absorbing member AP preferably extends from the first bottom surface 42f to the curved surface 42g. In other words, the polarized light absorbing member AP extends to a round portion of the boundary between the first bottom surface 42f and the second lateral surface 42e of the second prism 42. Note that the curved surface 42g is also a portion of the second lateral surface 42c, and it can be said in this case that the polarized light absorbing member AP is provided at the first bottom surface 42f and a portion of the second lateral surface 42c.

The polarized light absorbing member AP is an absorptive polarizer plate APm. The absorptive polarizer plate APm is a uniaxially stretched polarizer plate. The surface at which the polarized light absorbing member AP is provided is not a glaring surface when viewed from the outside. The transmission axis of the polarized light absorbing member AP is parallel or substantially parallel to the transmission axis of a polarization separation film 45 of the inclining mirror portion IM, which will be described later. In other words, the transmission axis of the polarized light absorbing member AP coincides or substantially coincides with the transmission axis of the polarization separation film 45. The transmission axis is a polarization axis that transmits only light vibrating in a specific direction. The term “substantially parallel” or “substantially coincide with” means that the deviation between the transmission axes falls within an angle ranging from 2° to 3°. The unnecessary outside light OL2 passes through the polarized light absorbing member AP, so that the same polarized light as the polarized light reflected off the polarization separation film 45 is absorbed. The remaining polarized light of the unnecessary outside light OL2 having passed through the polarized light absorbing member AP, even when reflected in the second prism 42, passes through the polarization separation film 45, so that reflection of the unnecessary outside light OL2 is suppressed. The unnecessary outside light OL2 therefore does not reach the eyes EY of the wearer US, so that a satisfactory field of view can be provided. Since the unnecessary outside light OL2 incident via the lower side of the prism-based light guide member 48 greatly affects the see-through ghost, the polarized light absorbing member AP is provided at the first bottom surface 42f of the second prism 42 and the like as described above.

In the present embodiment, the polarized light absorbing member AP is, for example, a member that is made of resin and absorbs or blocks s-polarized light PLs. The polarized light absorbing member AP, when configured to transmit, for example, p-polarized light PLp, transmits part of the unnecessary outside light OL2. The transmittance of the polarized light absorbing member AP is, for example, greater than or equal to 40% but smaller than or equal to 50%. When the transmittance ranges from 40% to 50%, the see-through performance of the surface at which the polarized light absorbing member AP is provided can be ensured to some extent. The thickness of the polarized light absorbing member AP is, for example, about 0.1 mm. The polarized light absorbing member AP may, for example, be attached to a base having the thickness of about 1 mm, or may be a film-shaped member. The surface of the polarized light absorbing member AP may be provided with a hard coat and an antireflection film.

When the polarized light absorbing member AP is disposed at the fourth bottom surface 40w of the first planar-plate-shaped member 40 and the fifth bottom surface 50w of the second planar-plate-shaped member 50, the polarized light absorbing member AP is attached with the transmission axis thereof adjusted after the first planar-plate-shaped member 40 and the second planar-plate-shaped member 50 are assembled. In this process, it is preferable that the polarized light absorbing member AP does not have a step. When the polarized light absorbing member AP is disposed only at the fourth bottom surface 40w of the first planar-plate-shaped member 40, the polarized light absorbing member AP is attached with the transmission axis thereof adjusted before or after the first planar-plate-shaped member 40 and the second planar-plate-shaped member 50 are assembled. An adhesive, an adhesive film, or the like can be used to attach the polarized light absorbing member AP.

The inclining mirror portion IM reflects at least part of the image light ML guided in the first prism 41. The inclining mirror portion IM is integrated with the first inclining surface 41d of the first prism 41, and sandwiched between the first inclining surface 41d of the first prism 41 and the second inclining surface 42d of the second prism 42. The space between the inclining mirror portion IM and the second inclining surface 42d is filled with an adhesive CT for bonding purposes. The inclining mirror portion IM and the second inclining surface 42d are not necessarily directly bonded to each other with the adhesive CT, and may be bonded to each other with an adhesive film or the like interposed therebetween. In the present embodiment, the inclining mirror portion IM is the polarization separation film 45. The polarization separation film 45 is, for example, a polarization beam splitter characterized by reflecting s-polarized light. The polarization separation film 45 is configured, for example, with a dielectric multilayer film, efficiently reflects the image light ML made of the s-polarized light PLs when the image light ML contains the s-polarized light PLs, and efficiently transmits the image light ML made of the p-polarized light PLp when the image light ML contains the p-polarized light PLp. The polarization separation film 45 may be any film that selectively reflects the image light ML in accordance with the polarization direction thereof, and may, for example, be a wire grid polarizer such as a multilayer film or a wire grid film, or a reflective polarization element using film stretching.

Note that the polarization separation film 45 may transmit the s-polarized light PLs and reflect the p-polarized light PLp.

The inclining mirror portion IM only needs to have a surface planar enough not to affect the image formation. The inclining mirror portion IM may have a slightly curved, convex or concave surface to the extent that the image formation is not affected. Note that the space between the inclining mirror portion IM and the first inclining surface 41d may be filled with a light transmissive filler in place of the adhesive CT. In this case, the first prism 41 and the second prism 42 may be supported by a support member or the like from outside to maintain the bonded state of the two prisms. The inclining mirror portion IM may instead be integrated with the second inclining surface 42d of the second prism 42 instead of the first inclining surface 41d of the first prism 41. The scratch resistance or scuff resistance of the inclining mirror portion IM can be enhanced by providing the surface thereof with a hard coat.

The second planar-plate-shaped member 50 includes the quarter-wave plate 51, which is a thin-plate-shaped plate, and the cover member 52. The quarter-wave plate 51 is a crystal or the like having an optic axis between the X direction and the Y direction. The quarter-wave plate 51 converts the image light ML made of the s-polarized light PLs reflected off the polarization separation film 45 into circularly polarized light PLc, and converts the image light ML made of the circularly polarized light PLc reflected off the cover member 52 into the p-polarized light PLp. The cover member 52 includes a planoconvex second lens 53, a planoconcave compensation lens 54, a compensation planar plate 55 provided around the compensation lens 54 and extending in parallel to the prism-based light guide member 48, and a transmissive mirror 56.

The second planar-plate-shaped member 50 is disposed at a distance ranging from about 20 μm to 50 μm from the first planar-plate-shaped member 40. The first outer surface 41c and the second outer surface 42c of the first planar-plate-shaped member 40 and a third inner surface 50c of the second planar-plate-shaped member 50 may potentially be slightly curved, so that a minute step may potentially be formed at the boundary between the first outer surface 41c and the second outer surface 42c, but setting the distance between the first and second outer surfaces 41c, 42c and the third inner surface 50c to 20 μm or greater, more preferably, 30 μm or greater can avoid a situation in which these surfaces are excessively close to each other. Conversely, setting the distance between the first and second outer surfaces 41c, 42c and the third inner surface 50c to 50 μm or smaller can avoid an increase in the thickness of the first combiner 103a, which is the combination of the first planar-plate-shaped member 40 and the second planar-plate-shaped member 50. A spacer 61 is provided between each of the first and second outer surfaces 41c, 42c of the first planar-plate-shaped member 40 and the third inner surface 50c of the second planar-plate-shaped member 50, the spacers 61 configured to adjust the distance between the first planar-plate-shaped member 40 and the second planar-plate-shaped member 50 and fix the two members positioned with respect to each other. The spacers 61 are not provided over the entire periphery of the second planar-plate-shaped member 50. That is, a gap SP between the first planar-plate-shaped member 40 and the second planar-plate-shaped member 50 is not sealed but communicates with the outside.

In the cover member 52, the second lens 53 collects the image light ML. The second lens 53 is a planoconvex lens that is thin but has positive refractive power. A planoconvex shape or a planoconvex lens has one surface having a planar shape, and another surface having an outwardly convex shape. The second lens 53 has a planar surface 53f bonded to the quarter-wave plate 51 and a convex surface 53g facing the compensation lens 54. The convex surface 53g is, for example, a spherical surface, and may instead be an axisymmetric aspherical surface. The convex surface 53g has a circular shape in the plan view. The compensation lens 54 is thin but has positive refractive power. The compensation lens 54 has a concave surface 54f facing the second lens 53, and a planar surface 54g. The compensation planar plate 55 is a plane parallel plate. The compensation planar plate 55 has a pair of planar surfaces 55f and 55g. The concave surface 54f of the compensation lens 54 has the same shape as the convex surface 53g of the second lens 53. The planar surface 54g of the compensation lens 54 and the planar surface 55g of the compensation planar plate 55 are in the same plane and are continuous with each other. The transmissive mirror 56 is a thin film formed on the convex surface 53g of the second lens 53, and has the same shape as the convex surface 53g. The combination of the second lens 53 and the transmissive mirror 56 is referred to as a light collecting reflector CR.

The second lens 53, the compensation lens 54, and the compensation planar plate 55 are made of a resin material and have the same refractive index. The refractive index of the second lens 53 and the like is lower than the refractive index of the first prism 41. The compensation lens 54 and the compensation planar plate 55 are made of the same resin material and integrated into an optical element 58.

The combination of the second lens 53, the compensation lens 54, and the compensation planar plate 55 functions as a plane parallel plate as a whole. That is, the outside light OL incident on the surfaces of the compensation lens 54 and the compensation planar plate 55 passes through the compensation lens 54 and the compensation planar plate 55 without being affected by the lens effects provided by the compensation lens 54 and the like and the step present at the outer edge of the compensation lens 54. The compensation lens 54 thus optically compensates for the influence of the second lens 53 on the outside light OL. In this sense, the planar surface 53f of the second lens 53, the planar surface 54g of the compensation lens 54, and the planar surfaces 55f and 55g of the compensation planar plate 55 are each not necessarily limited to a planar surface in an exact sense, and may, for example, each be a substantially planar surface or may each partially or entirely include a curved surface. In addition, the planar surface 53f of the second lens 53, the planar surface 54g of the compensation lens 54, and the planar surfaces 55f and 55g of the compensation planar plate 55 may each include a curved surface for correcting the eyesight of the wearer US or a curved surface for a good appearance such as that of sunglasses or non-prescribed glasses to the extent that no inconvenience occurs in terms of optical performance. The planar surfaces 54g and 55g of the compensation lens 54 and the compensation planar plate 55 may each be provided with an antireflection film or a hard coat. The outside light OL passing through the compensation planar plate 55 passes through the portion around the compensation lens 54. The outside light OL is incident via a peripheral region outside the region on which the image light ML is incident and which corresponds to the compensation lens 54, that is, via the compensation planar plate 55. A wide see-through field of view with respect to the outside can thus be ensured. The range of the field of view of the outside light OL is set, for example, to about 40° in the upward direction and about 40° in the downward direction.

The transmissive mirror 56 is a half-silvered mirror. The transmissive mirror 56 partially reflects the image light ML having passed through the second lens 53 and partially transmits the outside light OL. The transmissive mirror 56 reflects toward the pupil position PP the image light ML reflected off the inclining mirror portion IM of the first planar-plate-shaped member 40 or the polarization separation film 45 and passing through the quarter-wave plate 51 and the second lens 53. The transmissive mirror 56 is a concave mirror that covers the pupil position PP, at which the eyes EY or the pupils thereof are disposed, has a concave shape toward the pupil position PP, and has a convex shape toward the outside. The pupil position PP or the aperture PPa at the pupil position PP is called an eye point or an eye box, and corresponds to an exit pupil EP of the first display portion 20a.

The transmissive mirror 56, which transmits part of the outside light OL, allows sec-through viewing of the outside, and can superimpose a virtual image on an image of the outside. In this process, the outside light OL passes through the first planar-plate-shaped member 40 and the second planar-plate-shaped member 50, but the planar-plate-shaped member 40 and 50 do not function as a lens for the outside light OL. The reflectance of the transmissive mirror 56 for the image light ML and the outside light OL is set to a value greater than or equal to 10% but smaller than or equal to 50% over an assumed range of the angle of incidence of image light ML from the viewpoint of ensuring the luminance of the image light ML and facilitating the observation of an image of the outside in the see-through viewing. The transmissive mirror 56 is, for example, in the form of a dielectric multilayer film configured with multiple dielectric layers each having an adjusted film thickness. The transmissive mirror 56 may be a monolayer or multilayer film made of metal such as Al or Ag and having an adjusted film thickness. The transmissive mirror 56 is formed, for example, by evaporation-based lamination.

In the first virtual image display apparatus 100A, the first lens 30, the lens portion 44, the second lens 53, and the transmissive mirror 56 each have positive refractive power and tend to cause divergent light to converge. The first lens 30, the lens portion 44, the second lens 53, and the transmissive mirror 56, including the body of the first prism 41, the second prism 42, and the like, function as the imaging optical system IS or the direct virtual image optical system DIS such as that of a simple microscope that forms an erect image. The thus configured first virtual image display apparatus 100A can form a virtual image resulting from formation of a real image at the display surface 11d of the first image forming element 11a and projection of the real image, for example, at infinity, or a virtual image resulting from formation of a real image at the display surface 11d and projection of the real image at a point several meters ahead. In this process, the refractive power of each of the first lens 30, the lens portion 44, the second lens 53, and the transmissive mirror 56 is adjusted to shorten the focal length of the imaging optical system IS, so that a desired magnification factor can be achieved.

Referring to FIG. 3, the longitudinal size ay of the first planar-plate-shaped member 40 or the second planar-plate-shaped member 50 is, for example, 34 mm, and the lateral size ax thereof is, for example, 40 mm. A thickness az of the first planar-plate-shaped member 40 in the frontward-rearward direction ranges, for example, from about 7 mm to 8 mm, and the total thickness of the combination of the first planar-plate-shaped member 40 and the second planar-plate-shaped member 50 is suppressed to a value ranging from about 7.5 mm to 8.5 mm. In the first planar-plate-shaped member 40, upper planar surfaces 40u are provided on the right and left opposite sides of the light incident optical surface 41a. The upper planar surfaces 40u are each a surface that does not allow light to pass therethrough. From the viewpoint of preventing stray light, light blockers (not shown) facing and covering the upper planar surfaces 40u may be disposed at the upper planar surfaces 40u, or light blockers may be applied to the upper planar surfaces 40u.

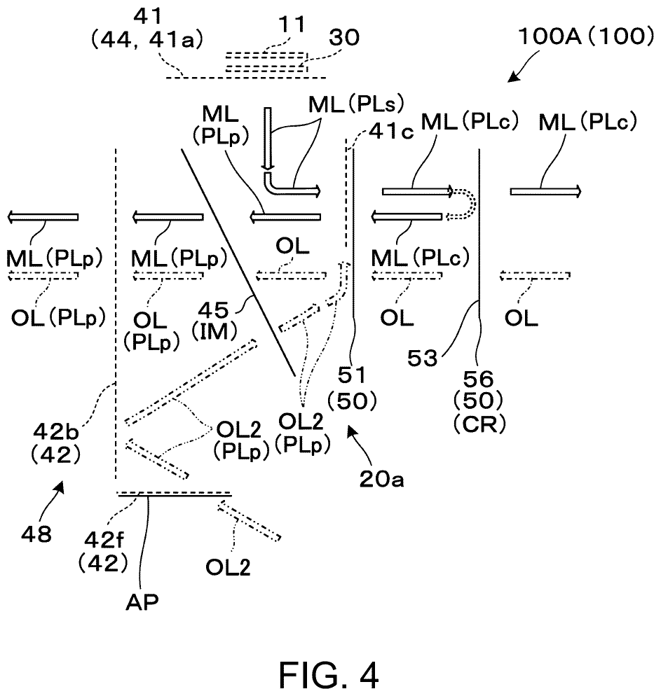

FIG. 4 illustrates the optical path and the like of the first virtual image display apparatus 100A. The image light ML from the first image forming element 11a enters the first prism 41 via the first lens 30, as shown in FIG. 4. In this process, the degree of divergence of the image light ML is suppressed by the positive refractive power of the first lens 30 and the lens portion 44. Along the optical path passing through the first prism 41, the image light ML does not form an intermediate image, but is sequentially reflected off the first inner surface 41b of the first prism 41 and the first outer surface 41c of the first prism 41 (see FIG. 2), and the s-polarized light PLs of the image light ML is reflected off the polarization separation film 45. The image light ML made of the s-polarized light PLs and reflected off the polarization separation film 45 passes through the first outer surface 41c of the first prism 41, passes through the quarter-wave plate 51 of the second planar-plate-shaped member 50, therefore becomes the circularly polarized light PLc, and enters the second lens 53 and the transmissive mirror 56. Part of the image light ML of the circularly polarized light PLc incident on the transmissive mirror 56 travels through the second lens 53, is reflected off the transmissive mirror 56, travels through the second lens 53, which collimates the image light ML, and the collimated image light ML passes through the quarter-wave plate 51 again. The image light ML having passed through the quarter-wave plate 51 becomes the p-polarized light PLp, enters the first prism 41 via the first outer surface 41c, passes through the polarization separation film 45, and exits out of the second prism 42 via the second inner surface 42b. The image light ML having exited out of the second prism 42 is incident on the pupil position PP, where the eyes EY or the pupils of the wearer US are disposed (see FIG. 2). Not only the image light ML having been reflected off the transmissive mirror 56 but also the outside light OL having passed through the transmissive mirror 56, and the outside light OL having passed through the compensation planar plate 55 arc incident on the pupil position PP. That is, the wearer US who wears the first virtual image display apparatus 100A can observe a virtual image produced by the image light ML and superimposed on an outside image.

In the present embodiment, when the unnecessary outside light OL2, which causes the see-through ghost, enters the second prism 42 via the first bottom surface 42f of the second prism 42, the s-polarized light PLs is absorbed by the polarized light absorbing member AP, and only the p-polarized light PLp enters the second prism 42. The p-polarized light PLp of the unnecessary outside light OL2 is then reflected off the second inner surface 42b of the second prism 42 and reaches the polarization separation film 45, but is not reflected off the polarization separation film 45. The unnecessary outside light OL2 therefore does not reach the eyes EY of the wearer US, and therefore does not form the see-through ghost. The wearer US can therefore have a satisfactory field of view.

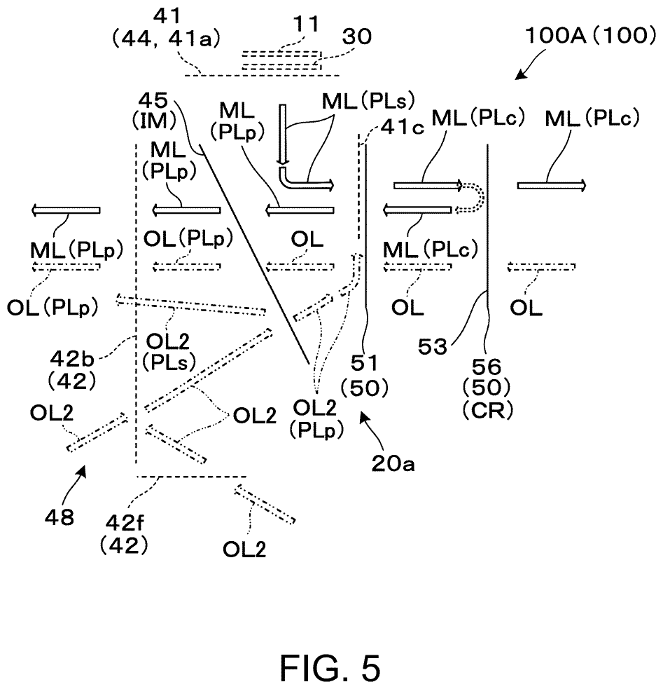

FIG. 5 illustrates the optical path and the like of a virtual image display apparatus according to Comparative Example. In the virtual image display apparatus according to Comparative Example, the unnecessary outside light OL2 from unintended directions, specifically, the unnecessary outside light OL2 that enters the prism-based light guide member 48 from the lower side, the inner side (side facing pupil position PP), and the lateral side of the prism-based light guide member 48 is reflected and otherwise processed in the prism-based light guide member 48 and reaches the eyes EY of the wearer US, as shown in FIG. 5. Since the unnecessary outside light OL2 is therefore captured in the field of view in the form of the see-through ghost, the field of view may deteriorate.

Specifically, the unnecessary outside light OL2 incident from the lower side of the prism-based light guide member 48, that is, via the first bottom surface 42f of the second prism 42 is reflected in the second prism 42 and reaches the polarization separation film 45, as shown in FIG. 5. The s-polarized light PLs of the unnecessary outside light OL2 incident on the polarization separation film 45 is reflected off the polarization separation film 45 and reaches the eyes EY of the wearer US. In this case, the wearer US visually recognizes the see-through ghost formed by the feet of the wearer US and the floor captured in the front field of view. The unnecessary outside light OL2 incident from the interior of the prism-based light guide member 48, that is, via the second inner surface 42b of the second prism 42 behaves in the same manner, that is, the s-polarized light PLs of the unnecessary outside light OL2 is reflected off the polarization separation film 45 and reaches the eyes EY of the wearer US. In this case, the wearer US visually recognizes the see-through ghost formed by the wearer US himself/herself captured on the front side of the field of view. In the present embodiment, in particular, providing the polarized light absorbing member AP at the first bottom surface 42f of the second prism 42 allows suppression of the unnecessary outside light OL2 from the obliquely lower front side, which greatly affects the see-through ghost.

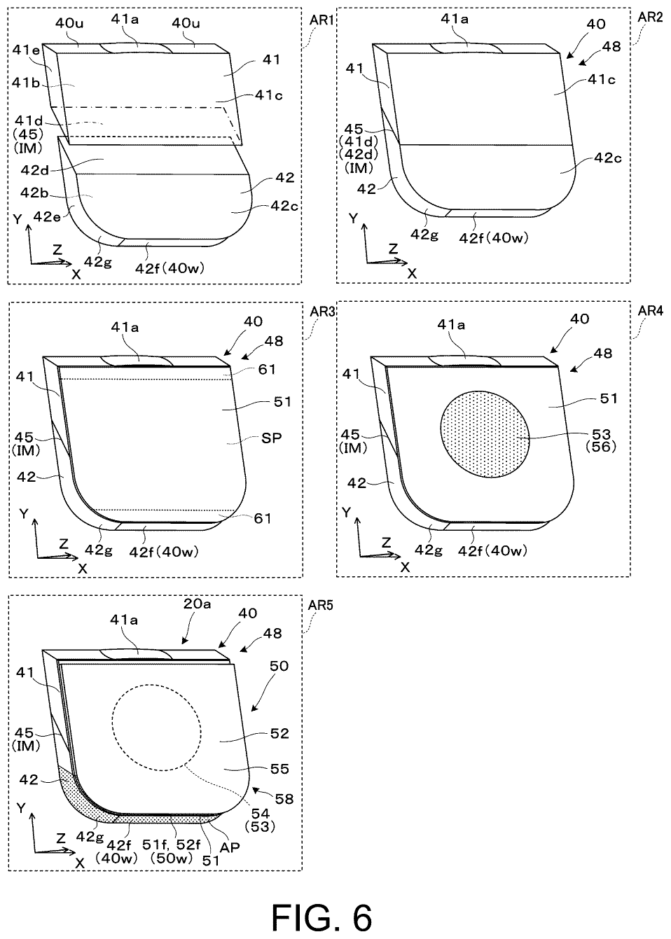

FIG. 6 illustrates an example of the structure and assembly of the first display portion 20a, which constitutes the first virtual image display apparatus 100A. In FIG. 6, regions AR1 to AR5 are perspective views illustrating the step of assembling the first display portion 20a. The first prism 41 and the second prism 42 are first provided, as shown in the region AR1. The first prism 41 and the second prism 42 are formed, for example, by injection molding of resin. The light incident optical surface 41a, the first inner surface 41b, the first outer surface 41c, the first inclining surface 41d, the first lateral surface 41e, the upper planar surfaces 40u, and the like are formed as the surfaces of the first prism 41. The second inner surface 42b, the second outer surface 42c, the second inclining surface 42d, the second lateral surface 42c, the first bottom surface 42f (or fourth bottom surface 40w), and the like are formed as the surfaces of the second prism 42. The polarization separation film 45 as the inclining mirror portion IM is formed on the first inclining surface 41d of the first prism 41 by vacuum evaporation or another method. The first prism 41 and the second prism 42 are bonded to each other at the inclining surfaces 41d and 42d, so that the prism-based light guide member 48 or the first planar-plate-shaped member 40 is produced, as shown in the region AR2. The quarter-wave plate 51 is then attached so as to face the outer surfaces 41c and 42c of the first planar-plate-shaped member 40, as shown in the region AR3. In this process, the spacers 61, which are a pair of thin adhesives, are each disposed between the corresponding one of the outer surfaces 41c and 42c of the first planar-plate-shaped member 40 and the quarter-wave plate 51, so that the gap SP is created between each of the outer surfaces 41c and 42c of the first planar-plate-shaped member 40 and the quarter-wave plate 51. The second lens 53 is attached to an appropriate location on the surface of the quarter-wave plate 51, as shown in the region AR4. The transmissive mirror 56 is formed at the surface of the second lens 53. The optical element 58 is then glued to the quarter-wave plate 51 and the like, as shown in the region AR5. In this process, the compensation lens 54 of the optical element 58 and the second lens 53 are positioned with respect to each other, and fitted and bonded to each other. The compensation planar plate 55 of the optical element 58 and the quarter-wave plate 51 are bonded to each other. The assembly of the first planar-plate-shaped member 40 and the second planar-plate-shaped member 50 of the first display portion 20a is thus completed. After the assembly is completed, the polarized light absorbing member AP is attached so as to extend over the bottom surface 40w of the first planar-plate-shaped member 40 and the bottom surface 50w of the second planar-plate-shaped member 50.

In the above description, the first display portion 20a is produced by assembling the second planar-plate-shaped member 50 on the first planar-plate-shaped member 40, but the first planar-plate-shaped member 40 and the second planar-plate-shaped member 50 may be separately assembled, and the first planar-plate-shaped member 40 and the second planar-plate-shaped member 50 may eventually be bonded to each other.

Note that the polarized light absorbing member AP may be attached to each member, specifically, the first bottom surface 42f of the second prism 42, the second bottom surface 51f of the quarter-wave plate 51, and the third bottom surface 52f of the cover member 52 before assembling the first display portion 20a. The polarized light absorbing member AP may be attached only to the first bottom surface 42f of the second prism 42.

The direct-virtual-image-type virtual image display apparatuses 100A and 100B or optical unit 100 according to the first embodiment described above includes the display element 11, which outputs the image light ML, the first lens 30, which the image light ML from the display element 11 enters, the first prism 41, which the image light ML having passed through the first lens 30 enters, the second prism 42, which is bonded to the first prism 41 to constitute the plane-parallel-plate-shaped prism-based light guide member 48, the inclining mirror portion IM, which is provided at the location where the first prism 41 and the second prism 42 are bonded to each other and reflects at least part of the image light ML guided in the first prism 41, the planoconvex second lens 53, which is disposed so as to face the first outer surface 41c of the first prism 41, which is the surface on which the image light ML reflected off the inclining mirror portion IM is incident, and the transmissive mirror 56, which is formed on the convex surface 53g of the second lens 53 and partially reflects toward the inclining mirror portion IM the image light ML reflected off the inclining mirror portion IM, and the second prism 42 includes the polarized light absorbing member AP at a surface excluding the second outer surface 42c facing the outside.

In the virtual image display apparatuses 100A and 100B or the optical unit 100 described above, the first lens 30, the second lens 53, and the transmissive mirror 56 ensure refractive power to directly form a virtual image without forming an intermediate image, and the magnification factor is ensured with an increase in the optical path length suppressed, so that an increase in the size of the optical system can be avoided. Furthermore, since the unnecessary outside light OL2, which causes the see-through ghost, passes through the polarized light absorbing member AP of the second prism 42, the see-through ghost can be effectively suppressed with the see-through performance of the field of view of the wearer US ensured, so that a satisfactory field of view can be provided.

### Second Embodiment

A virtual image display apparatus and the like according to a second embodiment will be described below. Note that the virtual image display apparatus according to the second embodiment is a partially changed version of the virtual image display apparatus according to the first embodiment, and portions common to those of the virtual image display apparatus according to the first embodiment will not be described.

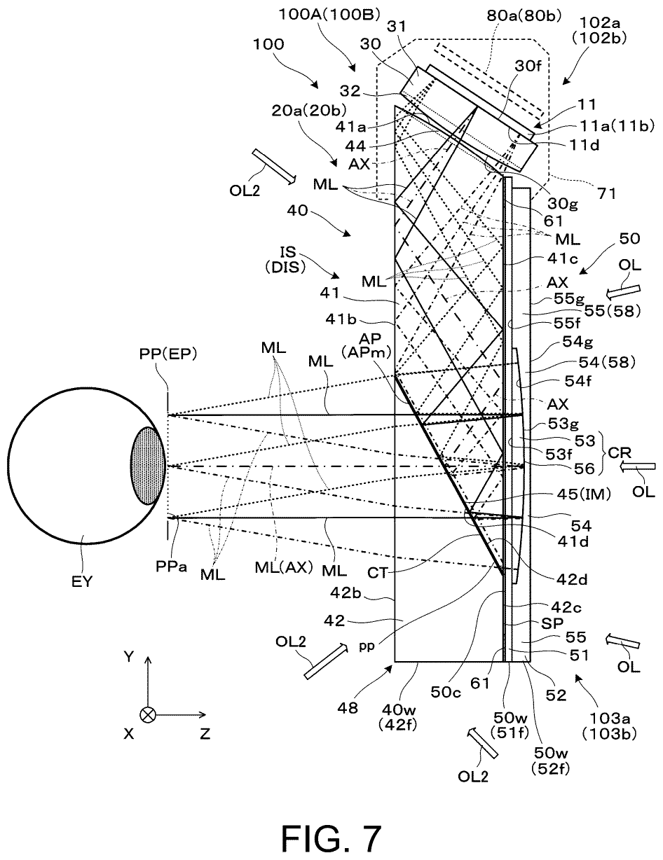

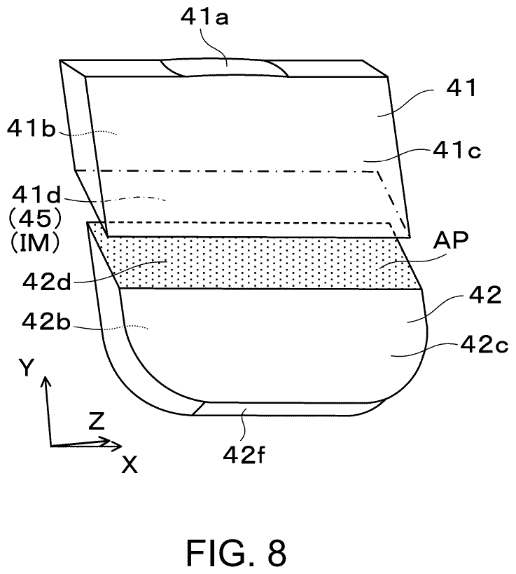

In the present embodiment, the polarized light absorbing member AP is disposed at the second inclining surface 42d of the second prism 42, which is the surface facing the inclining mirror portion IM, at a position close to the second inner surface 42b on the side opposite the second outer surface 42c with respect to the polarization separation film 45 of the inclining mirror portion IM, as shown in FIGS. 7 and 8. That is, the polarized light absorbing member AP is provided at the second inclining surface 42d of the second prism 42 on a side of the inclining mirror portion IM that is the side facing the wearer US or the observation side. The unnecessary outside light OL2 therefore passes through the polarized light absorbing member AP before being incident on the inclining mirror portion IM, so that reflection of the unnecessary outside light OL2 at the inclining mirror portion IM is suppressed. A situation in which the unnecessary outside light OL2 reaches the eyes EY of the wearer US can therefore be suppressed.

The polarized light absorbing member AP is attached to the second inclining surface 42d of the second prism 42 with the transmission axis of the polarized light absorbing member AP adjusted before the first prism 41 and the second prism 42 are assembled. Note that the polarized light absorbing member AP may be attached to the surface of the polarization separation film 45 of the inclining mirror portion IM at the first inclining surface 41d of the first prism 41 with the transmission axis of the polarized light absorbing member AP adjusted.

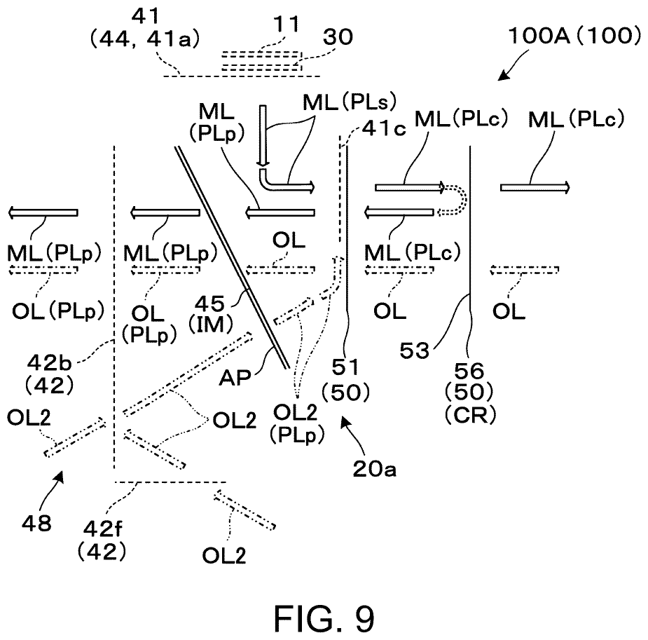

In the virtual image display apparatus 100A according to the present embodiment, the s-polarized light PLs of the unnecessary outside light OL2 incident via the first bottom surface 42f or the second inner surface 42b of the second prism 42, which causes the see-through ghost, is absorbed by the polarized light absorbing member AP immediately before the unnecessary outside light OL2 is incident on the polarization separation film 45, that is, when the unnecessary outside light OL2 enters the second prism 42 via the first bottom surface 42f or the second inner surface 42b of the second prism 42, so that only the p-polarized light PLp of the unnecessary outside light OL2 enters the second prism 42, as shown in FIG. 9. The p-polarized light PLp of the unnecessary outside light OL2 is reflected in the second prism 42 and reaches the polarization separation film 45, but is not reflected off the polarization separation film 45. The unnecessary outside light OL2 therefore does not reach the eyes EY of the wearer US, and therefore does not form the see-through ghost. The wearer US can therefore have a satisfactory field of view.

### Third Embodiment

A virtual image display apparatus and the like according to a third embodiment will be described below. Note that the virtual image display apparatus according to the third embodiment is a partially changed version of the virtual image display apparatus according to the first embodiment, and portions common to those of the virtual image display apparatus according to the first embodiment will not be described.

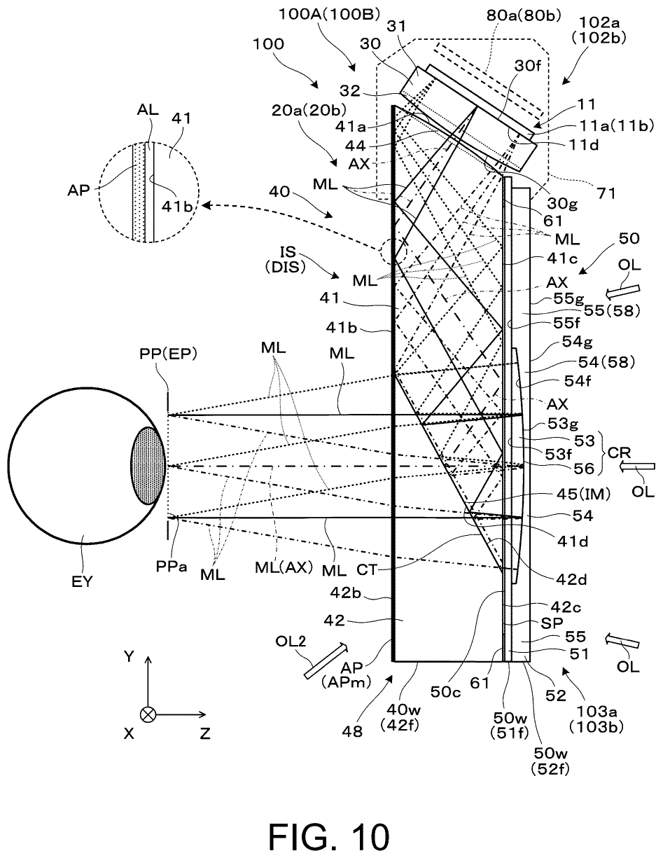

In the present embodiment, the polarized light absorbing member AP is disposed at the second inner surface 42b of the second prism 42, which is a surface on the side opposite the second outer surface 42c, as shown in FIG. 10. That is, the polarized light absorbing member AP is provided at the second inner surface 42b of the second prism 42. The unnecessary outside light OL2 incident via the second inner surface 42b of the second prism 42 therefore passes through the polarized light absorbing member AP before being incident on the inclining mirror portion IM, so that the reflection of the unnecessary outside light OL2 at the inclining mirror portion IM is suppressed. A situation in which the unnecessary outside light OL2 reaches the eyes EY of the wearer US can therefore be suppressed. The polarized light absorbing member AP may instead be disposed across the first inner surface 41b of the first prism 41, which is a surface on the side opposite the first outer surface 41c, as shown in FIG. 10. That is, the polarized light absorbing member AP may be provided at the entire inner surfaces 41b and 42b of the prism-based light guide member 48. The influence of the unnecessary outside light OL2 incident via the first inner surface 41b of the first prism 41 can thus also be suppressed. In the first prism 41, the polarized light absorbing member AP is disposed at the first inner surface 41b with an air layer AL interposed therebetween. Even when the first prism 41 is provided with the polarized light absorbing member AP, the air layer AL is interposed between the first prism 41 and the polarized light absorbing member AP, and therefore does not prevent the image light ML from being reflected in the first prism 41, so that the image light ML is totally reflected in the first prism 41. The configuration described above prevents the image light ML from entering the polarized light absorbing member AP. As a result, the configuration described above prevents the polarized image light ML reflected back off the polarization separation film 45, specifically, the s-polarized light PLs from being absorbed by the polarized light absorbing member AP and hence prevents an image formed by the s-polarized light PLs from being invisible.

When the polarized light absorbing member AP is provided only at the second inner surface 42b of the second prism 42, the polarized light absorbing member AP is attached with the transmission axis thereof adjusted before or after the first prism 41 and the second prism 42 are assembled. The polarized light absorbing member AP may instead be attached with the transmission axis thereof adjusted before or after the first planar-plate-shaped member 40 and the second planar-plate-shaped member 50 are assembled. When the polarized light absorbing member AP is disposed at the second inner surface 42b of the second prism 42 and the first inner surface 41b of the first prism 41, the polarized light absorbing member AP is attached with the transmission axis thereof adjusted after the first prism 41 and the second prism 42 are assembled. In this case, the air layer AL is provided between the first prism 41 and the polarized light absorbing member AP by using a spacer or the like that is not shown.

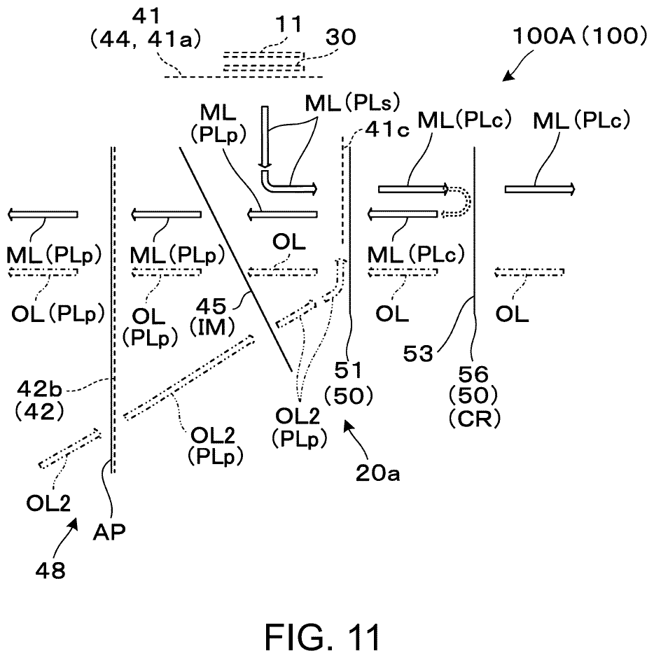

In the virtual image display apparatus 100A according to the present embodiment, the s-polarized light PLs of the unnecessary outside light OL2 incident via the second inner surface 42b of the second prism 42, which causes the see-through ghost, is absorbed by the polarized light absorbing member AP when the unnecessary outside light OL2 enters the second prism 42 via the second inner surface 42b of the second prism 42, so that only the p-polarized light PLp of the unnecessary outside light OL2 enters the second prism 42, as shown in FIG. 11. The p-polarized light PLp of the unnecessary outside light OL2 is reflected in the second prism 42 and reaches the polarization separation film 45 of the inclining mirror portion IM, but is not reflected off the polarization separation film 45. The unnecessary outside light OL2 therefore does not reach the eyes EY of the wearer US, and therefore does not form the see-through ghost. The wearer US can therefore have a satisfactory field of view.

### Fourth Embodiment

A virtual image display apparatus and the like according to a fourth embodiment will be described below. Note that the virtual image display apparatus according to the fourth embodiment is a partially changed version of the virtual image display apparatus according to the first embodiment, and portions common to those of the virtual image display apparatus according to the first embodiment will not be described.

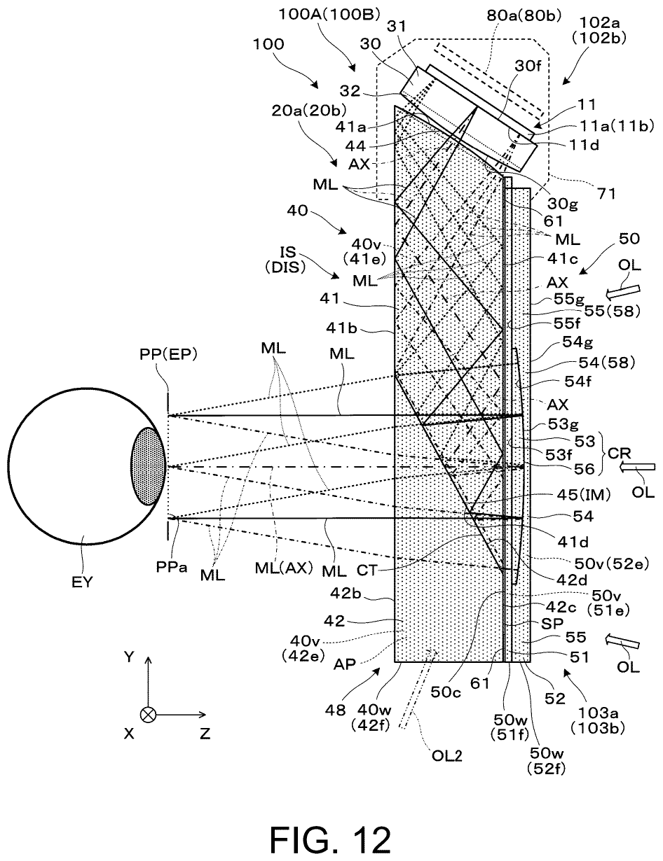

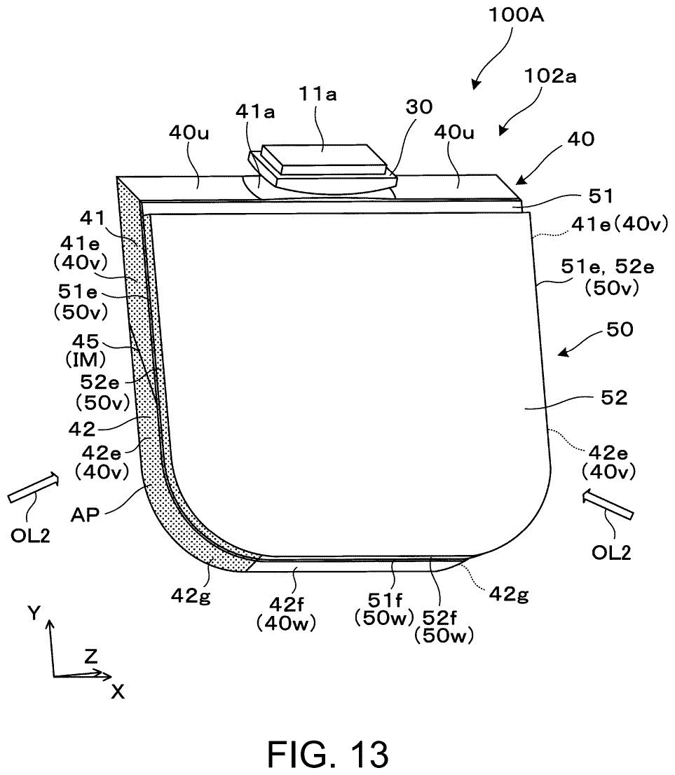

In the present embodiment, the polarized light absorbing member AP is disposed at the second lateral surface 42e of the second prism 42, as shown in FIGS. 12 and 13. That is, the polarized light absorbing member AP is provided at the second lateral surface 42e of the second prism 42. The unnecessary outside light OL2 incident via the second lateral surface 42e of the second prism 42 therefore passes through the polarized light absorbing member AP before being incident on the inclining mirror portion IM, so that the reflection of the unnecessary outside light OL2 at the inclining mirror portion IM is suppressed. A situation in which the unnecessary outside light OL2 reaches the eyes EY of the wearer US can therefore be suppressed. It is preferable that the polarized light absorbing member AP is disposed at the second lateral surface 42c of the second prism 42, the first lateral surface 41e of the first prism 41, a third lateral surface 51e of the quarter-wave plate 51, and a fourth lateral surface 52e of the cover member 52, as shown in FIG. 12 and the like. That is, it is preferable that the polarized light absorbing member AP is provided across the fifth lateral surface 40v of the first planar-plate-shaped member 40 and a sixth lateral surface 50v of the second planar-plate-shaped member 50. The see-through ghost can thus be further suppressed.

When the polarized light absorbing member AP is provided only at the second lateral surface 42e of the second prism 42, the polarized light absorbing member AP is attached with the transmission axis thereof adjusted before or after the first prism 41 and the second prism 42 are assembled. The polarized light absorbing member AP may instead be attached with the transmission axis thereof adjusted before or after the first planar-plate-shaped member 40 and the second planar-plate-shaped member 50 are assembled. When the polarized light absorbing member AP is disposed at the second lateral surface 42e of the second prism 42, the first lateral surface 41e of the first prism 41, the third lateral surface 51e of the quarter-wave plate 51, and the fourth lateral surface 52e of the cover member 52, the polarized light absorbing member AP is attached with the transmission axis thereof adjusted after the first planar-plate-shaped member 40 and the second planar-plate-shaped member 50 are assembled.

In the virtual image display apparatus 100A according to the present embodiment, the s-polarized light PLs of the unnecessary outside light OL2 incident sideways, which causes the sec-through ghost, is absorbed by the polarized light absorbing member AP when the unnecessary outside light OL2 enters the second prism 42 via the second lateral surface 42e of the second prism 42, so that only the p-polarized light PLp of the unnecessary outside light OL2 enters the second prism 42. The p-polarized light PLp of the unnecessary outside light OL2 is reflected in the second prism 42 and reaches the polarization separation film 45 of the inclining mirror portion IM, but is not reflected off the polarization separation film 45. The unnecessary outside light OL2 therefore does not reach the eyes EY of the wearer US and therefore does not form the see-through ghost. The wearer US can therefore have a satisfactory field of view.

### Variations and Others

The present disclosure has been described above with reference to the embodiments, but is not limited to the embodiments described above, and can be implemented in various aspects without departing from the key points of the present disclosure. For example, variations below are conceivable.

The arrangements of the polarized light absorbing members AP shown in the first to fourth embodiments may be combined with each other. Combining the multiple arrangements of the polarized light absorbing members AP described above allows more favorable suppression of the see-through ghost. The transmission axis of each of the polarized light absorbing members AP is parallel or substantially parallel to the transmission axis of the polarization separation film 45, and therefore does not affect the image light ML or the outside light OL.

In the above description, the HMD 200 includes the first virtual image display apparatus 100A and the second virtual image display apparatus 100B, but the HMD 200 may support the single first virtual image display apparatus 100A or second virtual image display apparatus 100B in front of the eyes with the aid of the support apparatuses 100C.

In the cover member 52, the compensation planar plate 55 can be omitted. In this case, the quarter-wave plate 51 is disposed only over the range of the second lens 53, and the second lens 53 is covered with the compensation lens 54.

In the second planar-plate-shaped member 50, the cover member 52 may be omitted.

In the first prism 41 of the first planar-plate-shaped member 40, the light incident optical surface 41a may be omitted. In this case, the lens portion 44 is omitted from the optical system.

The first lens 30 is not necessarily bonded to the first image forming element 11a, and may be disposed separately from the first image forming element 11a.

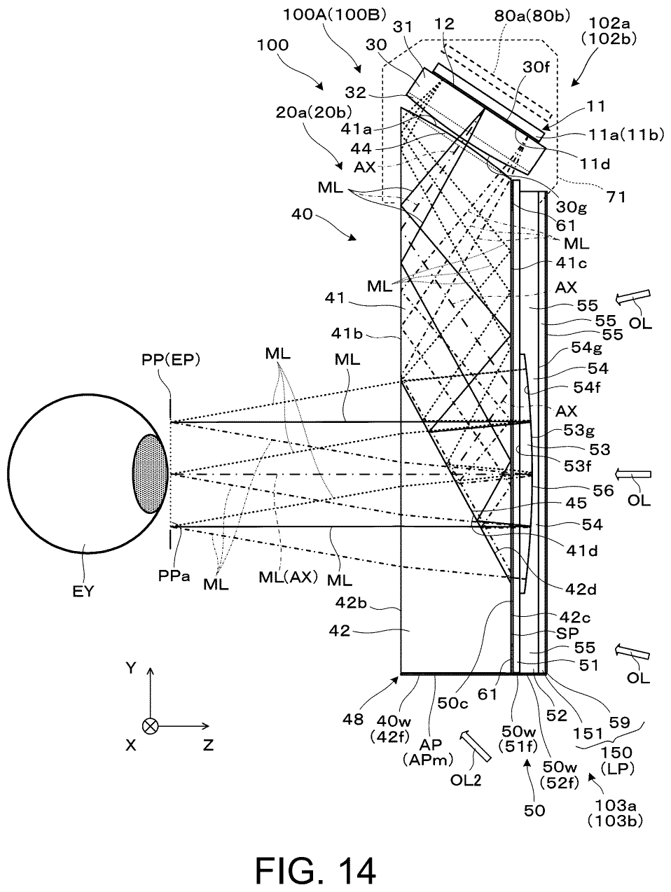

In the first virtual image display apparatus 100A, for example, an s-polarized light transmissive polarizer plate 12 may be disposed between the first lens 30 and the display element 11 in the first display portion 20a, as shown in FIG. 14. Furthermore, in the first display portion 20a, a third planar-plate-shaped member 150 is added on a side of the second planar-plate-shaped member 50 that is the side facing the outside. The third planar-plate-shaped member 150 is an image light blocker LP. The third planar-plate-shaped member 150 includes an outer quarter-wave plate 151 provided on a side of the transmissive mirror 56 or the light collecting reflector CR that is the side facing the outside, and a polarizer plate 59 provided on a side of the outer quarter-wave plate 151 that is the side facing the outside. That is, the first display portion 20a has a structure in which the inner quarter-wave plate 51 and the outer quarter-wave plate 151 are disposed between the inner polarization separation film 45 and the outer polarizer plate 59. The polarizer plate 59 selectively absorbs the image light ML having passed through the outer quarter-wave plate 151 in accordance with the polarization direction of the image light ML. In the example shown in FIG. 14, the polarized light absorbing member AP is also provided at the bottom surface of the third planar-plate-shaped member 150 in addition to the bottom surface 40w of the first planar-plate-shaped member 40 and the bottom surface 50w of the second planar-plate-shaped member 50.

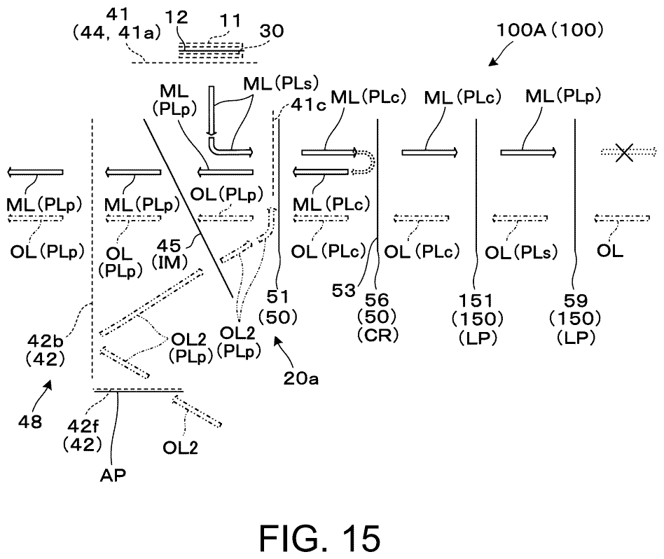

The image light ML made of the circularly polarized light PLc having passed through the transmissive mirror 56 becomes the p-polarized light PLp after passing through the outer quarter-wave plate 151, enters the polarizer plate 59, which blocks most of the p-polarized light PLp, as shown in FIG. 15. That is, the image light ML is blocked by the third planar-plate-shaped member 150 and does not leak out of the first virtual image display apparatus 100A. The third planar-plate-shaped member 150 prevents the image light ML from being observed from the outside, so that privacy of the wearer US can be ensured. In contrast, the outside light OL having entered the polarizer plate 59 becomes only the s-polarized light PLs after passing through the polarizer plate 59, becomes the circularly polarized light PLc after passing through the outer quarter-wave plate 151, and partially passes through the transmissive mirror 56. The outside light OL made of the circularly polarized light PLc having partially passed through the transmissive mirror 56 becomes the p-polarized light PLp after passing through the inner quarter-wave plate 51, passes through the polarization separation film 45, and is incident on the pupil position PP.

A direct-virtual-image-type virtual image display apparatus in a specific aspect includes: a display element configured to output image light; a first lens that the image light from the display element enters; a first prism that the image light passing through the first lens enters; a second prism bonded to the first prism to constitute a plane-parallel-plate-shaped prism-based light guide member; an inclining mirror portion provided at a location where the first prism and the second prism are bonded to each other and configured to reflect at least part of the image light guided in the first prism; a planoconvex second lens disposed so as to face a first outer surface of the first prism that is a surface on which the image light reflected off the inclining mirror portion is incident; and a transmissive mirror formed on a convex surface of the second lens and configured to partially reflect toward the inclining mirror portion the image light reflected off the inclining mirror portion, and the second prism includes a polarized light absorbing member at a surface excluding a second outer surface facing an outside.

In the virtual image display apparatus described above, the first lens, the second lens, and the transmissive mirror ensure refractive power to directly form a virtual image without forming an intermediate image, and the magnification factor is ensured with an increase in the optical path length suppressed, so that an increase in the size of the optical system can be avoided. Furthermore, since unnecessary outside light that causes a see-through ghost passes through the polarized light absorbing member of the second prism, the see-through ghost can be effectively suppressed with the see-through performance of the field of view of a wearer ensured, so that a satisfactory field of view can be provided.

In the virtual image display apparatus according to the specific aspect, the polarized light absorbing member is an absorptive polarizer plate.

The virtual image display apparatus according to the specific aspect further includes a quarter-wave plate disposed between the first outer surface of the first prism and a planar surface of the second lens, the inclining mirror portion includes a polarization separation film configured to selectively reflect the image light in accordance with a polarization direction of the image light, and a transmission axis of the polarized light absorbing member is parallel to a transmission axis of the polarization separation film. In this case, the unnecessary outside light passes through the polarized light absorbing member, so that the same polarized light as the polarized light reflected off the polarization separation film is absorbed. The remaining polarized light of the unnecessary outside light having passed through the polarized light absorbing member passes through the polarization separation film even when reflected in the second prism, so that the reflection of the unnecessary outside light is suppressed. The unnecessary outside light therefore does not reach the eyes of the wearer, so that a satisfactory field of view can be provided.

In the virtual image display apparatus in the specific aspect, the polarized light absorbing member is disposed at a first bottom surface of the second prism. In this case, the unnecessary outside light incident from the obliquely lower front side passes through the polarized light absorbing member before being incident on the inclining mirror portion, so that reflection of the unnecessary outside light at the inclining mirror portion is suppressed. The situation in which the unnecessary outside light reaches the eyes of the wearer can thus be suppressed.

In the virtual image display apparatus in the specific aspect, the polarized light absorbing member is disposed at a first bottom surface of the second prism, a second bottom surface of the quarter-wave plate, and a third bottom surface of a cover member including the second lens and the transmissive mirror. In this case, the see-through ghost can be further suppressed.

In the virtual image display apparatus in the specific aspect, the second prism has a curved surface at a boundary between the first bottom surface and a second lateral surface, and the polarized light absorbing member extends from the first bottom surface to the curved surface.

In the virtual image display apparatus in the specific aspect, the polarized light absorbing member is disposed at an inclining surface of the second prism that is a surface facing the inclining mirror portion at a position close to a second inner surface of the second prism that is a surface on a side opposite the second outer surface of the second prism with respect to the inclining mirror portion. In this case, the unnecessary outside light passes through the polarized light absorbing member before being incident on the inclining mirror portion, so that reflection of the unnecessary outside light at the inclining mirror portion is suppressed. The situation in which the unnecessary outside light reaches the eyes of the wearer can thus be suppressed.

In the virtual image display apparatus in the specific aspect, the polarized light absorbing member is disposed at a second inner surface of the second prism that is a surface on a side opposite the second outer surface of the second prism. In this case, the unnecessary outside light incident via the second inner surface of the second prism passes through the polarized light absorbing member before being incident on the inclining mirror portion, so that reflection of the unnecessary outside light at the inclining mirror portion is suppressed. The situation in which the unnecessary outside light reaches the eyes of the wearer can thus be suppressed.

In the virtual image display apparatus in the specific aspect, the polarized light absorbing member is disposed at a first inner surface of the first prism via an air layer, the first inner surface being on a side opposite the first outer surface of the first prism, which is a surface facing an outside. In this case, the influence of the unnecessary outside light incident via the first inner surface of the first prism can also be suppressed. Even when the first prism is provided with the polarized light absorbing member, the air layer is interposed between the first prism and the polarized light absorbing member, and does not prevent the image light from being reflected in the first prism.

In the virtual image display apparatus in the specific aspect, the polarized light absorbing member is disposed at a second lateral surface of the second prism. In this case, the unnecessary outside light incident via the second lateral surface passes through the polarized light absorbing member before being incident on the inclining mirror portion, so that reflection of the unnecessary outside light at the inclining mirror portion is suppressed. The situation in which the unnecessary outside light reaches the eyes of the wearer can thus be suppressed.

In the virtual image display apparatus in the specific aspect, the polarized light absorbing member is disposed at a second lateral surface of the second prism, a first lateral surface of the first prism, a third lateral surface of the quarter-wave plate, and a fourth lateral surface of a cover member including the second lens and the transmissive mirror. In this case, the see-through ghost can be further suppressed.

In the virtual image display apparatus in the specific aspect, transmittance of the polarized light absorbing member is greater than or equal to 40% but smaller than or equal to 50%. In this case, the see-through performance of the surface at which the polarized light absorbing member is provided can be ensured to some extent.

In the virtual image display apparatus in the specific aspect, the first lens, the prism-based light guide member, the inclining mirror portion, the second lens, and the transmissive mirror constitute an imaging optical system of a simple microscope configured to form an erect image, and the first prism is configured to internally reflect the image light twice while causing the image light to diverge. In this case, the distance from the display element to the transmissive mirror can be readily shortened, so that the prism-based light guide member can be reduced in size, and the display element and the first lens are also readily reduced in size.

A direct-virtual-image-type optical unit in a specific aspect includes: a first lens that image light from a display element enters; a first prism that the image light passing through the first lens enters; a second prism bonded to the first prism to constitute a plane-parallel-plate-shaped prism-based light guide member; an inclining mirror portion provided at a location where the first prism and the second prism are bonded to each other and configured to reflect at least part of the image light guided in the first prism; a planoconvex second lens disposed so as to face a first outer surface of the first prism that is a surface on which the image light reflected off the inclining mirror portion is incident; and a transmissive mirror formed on a convex surface of the second lens and configured to partially reflect toward the inclining mirror portion the image light reflected off the inclining mirror portion, and the second prism includes a polarized light absorbing member at a surface excluding a second outer surface facing an outside.

What is claimed is:

1. A direct-virtual-image-type virtual image display apparatus comprising:
a display element configured to output image light;
a first lens that the image light from the display element enters;
a first prism that the image light passing through the first lens enters;
a second prism bonded to the first prism to constitute a plane-parallel-plate-shaped prism-based light guide member;
an inclining mirror portion provided at a location where the first prism and the second prism are bonded to each other and configured to reflect at least part of the image light guided in the first prism;
a planoconvex second lens disposed so as to face a first outer surface of the first prism that is a surface on which the image light reflected off the inclining mirror portion is incident; and
a transmissive mirror formed on a convex surface of the second lens and configured to partially reflect toward the inclining mirror portion the image light reflected off the inclining mirror portion,
wherein the second prism includes a polarized light absorbing member at a surface excluding a second outer surface facing an outside.

2. The direct-virtual-image-type virtual image display apparatus according to claim 1, wherein
the polarized light absorbing member is an absorptive polarizer plate.

3. The direct-virtual-image-type virtual image display apparatus according to claim 1, further comprising
a quarter-wave plate disposed between the first outer surface of the first prism and a planar surface of the second lens,
wherein the inclining mirror portion includes a polarization separation film configured to selectively reflect the image light in accordance with a polarization direction of the image light, and
a transmission axis of the polarized light absorbing member is parallel to a transmission axis of the polarization separation film.

4. The direct-virtual-image-type virtual image display apparatus according to claim 1,
wherein the polarized light absorbing member is disposed at a first bottom surface of the second prism.

5. The direct-virtual-image-type virtual image display apparatus according to claim 3,
wherein the polarized light absorbing member is disposed at a first bottom surface of the second prism, a second bottom surface of the quarter-wave plate, and a third bottom surface of a cover member including the second lens and the transmissive mirror.

6. The direct-virtual-image-type virtual image display apparatus according to claim 4,
wherein the second prism has a curved surface at a boundary between the first bottom surface and a second lateral surface, and
the polarized light absorbing member extends from the first bottom surface to the curved surface.

7. The direct-virtual-image-type virtual image display apparatus according to claim 1,
wherein the polarized light absorbing member is disposed at an inclining surface of the second prism that is a surface facing the inclining mirror portion at a position close to a second inner surface of the second prism that is a surface on a side opposite the second outer surface of the second prism with respect to the inclining mirror portion.

8. The direct-virtual-image-type virtual image display apparatus according to claim 1,
wherein the polarized light absorbing member is disposed at a second inner surface of the second prism that is a surface on a side opposite the second outer surface of the second prism.

9. The direct-virtual-image-type virtual image display apparatus according to claim 8,
wherein the polarized light absorbing member is disposed at a first inner surface of the first prism via an air layer, the first inner surface being on a side opposite the first outer surface of the first prism, which is a surface facing an outside.

10. The direct-virtual-image-type virtual image display apparatus according to claim 1,
wherein the polarized light absorbing member is disposed at a second lateral surface of the second prism.

11. The direct-virtual-image-type virtual image display apparatus according to claim 3,
wherein the polarized light absorbing member is disposed at a second lateral surface of the second prism, a first lateral surface of the first prism, a third lateral surface of the quarter-wave plate, and a fourth lateral surface of a cover member including the second lens and the transmissive mirror.

12. The direct-virtual-image-type virtual image display apparatus according to claim 1,
wherein transmittance of the polarized light absorbing member is greater than or equal to 40% but smaller than or equal to 50%.

13. The direct-virtual-image-type virtual image display apparatus according to claim 1,
wherein the first lens, the prism-based light guide member, the inclining mirror portion, the second lens, and the transmissive mirror constitute an imaging optical system of a simple microscope configured to form an erect image, and
the first prism is configured to internally reflect the image light twice while causing the image light to diverge.

14. A direct-virtual-image-type optical unit comprising:
a first lens that image light from a display element enters;
a first prism that the image light passing through the first lens enters;
a second prism bonded to the first prism to constitute a plane-parallel-plate-shaped prism-based light guide member;
an inclining mirror portion provided at a location where the first prism and the second prism are bonded to each other and configured to reflect at least part of the image light guided in the first prism;
a planoconvex second lens disposed so as to face a first outer surface of the first prism that is a surface on which the image light reflected off the inclining mirror portion is incident; and
a transmissive mirror formed on a convex surface of the second lens and configured to partially reflect toward the inclining mirror portion the image light reflected off the inclining mirror portion,
wherein the second prism includes a polarized light absorbing member at a surface excluding a second outer surface facing an outside.
